(19) United States
(12) Patent Application Publication
(10) Pub. No.: US 2018/0148330 A1
(43) Pub. Date: May 31, 2018

(54) METHODS FOR STEAM METHANE REFORMING

(71) Applicants: Satish S. Tamhankar, Scotch Plains, NJ (US); Raju Natarajan, Acworth, GA (US); Ramachandran Krishnamurthy, Piscataway, NJ (US); Rachid Mabrouk, Munich (DE)

(72) Inventors: Satish S. Tamhankar, Scotch Plains, NJ (US); Raju Natarajan, Acworth, GA (US); Ramachandran Krishnamurthy, Piscataway, NJ (US); Rachid Mabrouk, Munich (DE)

(21) Appl. No.: 15/364,883

(22) Filed: Nov. 30, 2016

(51) Int. Cl. C01B 3/40; C01B 3/38; B01J 23/755; B01J 23/46; B01J 21/04; B01J 23/745; B01J 35/00; B01J 35/04; B01J 37/02

(52) U.S. Cl. CPC C01B 3/40; C01B 2203/1614; B01J 23/755; B01J 23/462; B01J 21/04; B01J 23/745; B01J 35/0006; B01J 35/04; B01J 37/0242; B01J 37/0236; C01B 2203/0233; C01B 2203/085; C01B 2203/1082; C01B 2203/1058; C01B 2203/1064; C01B 2203/1241; C01B 2203/1247; C01B 3/384

(57) ABSTRACT

A method for producing hydrogen in a steam methane reformer is disclosed. The method provides for the steps of feeding a mixture of fuel and air to a steam methane reformer; feeding a mixture of steam and hydrocarbons to the steam methane reformer; contacting the steam and hydrocarbons with a metal monolith supported catalyst; providing an electric current to the metal monolith supported catalyst; and recovering the hydrogen. The electric current applied to the metal monolith supported catalyst will encounter electrical resistance which will create heat. This heat can supplement that provided for by the reaction of the fuel and air allowing for a reduction in fueling costs as well as treatment costs of the resultant flue gas.

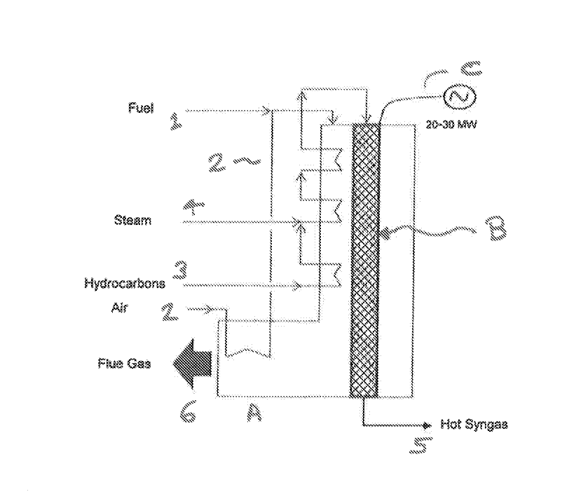

### BACKGROUND OF THE INVENTION

The present invention relates to an improved method for performing steam methane reforming by using excess electrical power to supply a portion of the reforming reaction heat.

Conventional hydrogen production plants that are based on steam methane reforming (SMR) typically operate at a temperature of 700° to 950° C. and at a pressure of 150 to 500 psig. One primary reason to operate at high pressure is to enable separation of hydrogen from the product synthesis gas using a pressure swing adsorption (PSA) method. However, reforming equilibrium is favored at lower pressures. Operation at high pressure and temperature further demands the use of expensive alloys for the construction of the reformer. Similar concerns arise for other types of hydrogen production processes, such as dry (carbon dioxide) reforming, catalytic or non-catalytic partial oxidation or auto-thermal reforming.

As part of the reaction process heat is required and the temperatures necessary for reformation will require a large energy input. This energy input thereby increases the cost of the reformation reaction.

The present invention uses electrical power by means of resistance heating which provides part of the reaction heat required for the reformation reaction. This will reduce operating costs of the reforming reaction due to reduced fuel consumption costs as well as a reduction in emissions such as carbon dioxide emissions associated with the burning of fuel.

### SUMMARY OF THE INVENTION

A method for producing hydrogen in a steam methane reformer comprising the steps:
a) Feeding a mixture of fuel and air to a steam methane reformer;
b) Feeding a mixture of steam and hydrocarbons to the steam methane reformer;
c) Contacting the steam and hydrocarbons with a metal monolith supported catalyst;
d) Providing an electric current to the metal monolith supported catalyst; and
e) Recovering the hydrogen.

In an alternative embodiment of the invention, there is disclosed a method for reducing the amount of fuel and air used in producing hydrogen in a steam methane reformer comprising the steps:
a) Feeding a mixture of fuel and air to a steam methane reformer;
b) Feeding a mixture of steam and hydrocarbons to the steam methane reformer;
c) Contacting the steam and hydrocarbons with a metal monolith supported catalyst;
d) Providing an electric current to the metal monolith supported catalyst; and
e) Recovering the hydrogen.

In another alternative embodiment of the invention, there is disclosed an improved method for producing hydrogen in a steam methane reformer comprising the steps:
a) Feeding a mixture of fuel and air to a steam methane reformer;
b) Feeding a mixture of steam and hydrocarbons to the steam methane reformer;
c) Contacting the steam and hydrocarbons with a metal monolith supported catalyst; and
d) Recovering the hydrogen, the improvement comprising feeding an electric current to the metal monolith supported catalyst.

The hydrogen that is formed is typically in a synthesis gas mixture with carbon monoxide so it can be treated by a separation process such as a pressure swing adsorption process to recover pure hydrogen. The carbon monoxide can be recovered and utilized in other aspects.

The steam methane reformer is a typical reforming unit allowing for the input of fuel and air as well as the steam and hydrocarbons used to produce hydrogen. The reforming unit will also contain a catalyst material which in this invention is a metal monolith supported catalyst.

The fuel that is combusted with air is typically a mixture of hydrocarbons such as those derived from tail gases and generally consists of the mixture of methane, ethane, ethylene, propane, propylene, butanes, pentanes and hexanes.

The combustion process is typically performed at atmospheric pressure or slightly negative pressure. The air is typically ambient air drawn into the steam methane reformer using a fan.

The air used for combustion is slightly compressed to overcome the pressure drop as the reformer furnace is slightly below atmospheric pressure.

Steam for the reaction is typically made using the waste heat from the process. The steam generation pressure is adjusted based on the reforming pressure.

The syngas that exiss the steam methane reformer is fed through a shift reactor to convert some of the carbon monoxide in this syngas to hydrogen which is then cooled to separate the condensate. High purity hydrogen can then be recovered from the syngas in the downstream purification system.

The heat in the flue gas is used to preheat the reformer feed and the combustion air and to produce steam.

The steam will react with the hydrocarbons at the elevated temperatures of about 700° to 1100° C. in the presence of the catalyst material to produce the hydrogen and carbon monoxide per reaction (1) described below.

In a typical steam methane reforming reaction, the heat required for the reaction is provided by the reaction of the fuel and the air to reach the elevated temperatures of about 700° to 950° C. In the present invention, an electrical current is fed to the metal monolith supported catalyst. The electrical resistance that results from the application of the current to the metal monolith supported catalyst will result in the generation of heat. This heat will supplement that amount of heat that is generated by the reaction of the fuel and air and thereby reduce the amount of heat that needs to be provided by this reaction.

The metal monolith supported catalyst is typically made of low alloy steel such as D64A, 300M or 256A low alloy steels. The catalyst is wash coated on the metallic support. This coating is typically performed in two steps; first, the metal structure support is coated with a ceramic material type alumina. This coating is dried and is then impregnated with a reforming material substrate selected from nickel or ruthenium type or any known reforming catalyst substrate.

The electrical current passes through the monolith or through an electrical rode implemented and passing through the metallic structure center. The heat released by the electrical resistance of the metallic structure or the electrical rode is controlled by the current passing through as defined in the following equations:

Q=V×I²(W)

=R×I²(W)

Where Q is the heat, V is the voltage, R is metal electrical resistance and I is the current.

Thus, the heat is controlled by controlling the current supply. The electrical source could be any convenient source ranging from conventional sources to green and renewable sources.

Depending on the feed stock used for synthesis gas production and the capacity targeted, the electrical power will provide the heat required for the reforming reactions. An example for methane reforming reaction is summarized as follows:

CH₄+H₂O→CO+2H₂ (Endothermic ΔHᵣ=206 kJ/mol)

CO+H₂O→CO₂+H₂ (Exothermic ΔHᵣ=−41 kJ/mol)

The electrical power provided will be up to 90% of that power which is provided by the fuel and air reaction which represents 10 to 15% of the total power duty required to operate the steam methane reformer.

Additionally, the electrical power could substitute for a part or all of the duty provided by purge gases from different sources, e.g. PSA tail gas, CO separation cold box if CO is one of the targeted products, etc.

The hydrocarbons that contact the metal monolith supported catalyst with the steam are typically unconverted methane and carbon monoxide, unrecovered hydrogen and carbon dioxide.

The steam employed may be from any readily available source of steam.

### BRIEF DESCRIPTION OF THE DRAWINGS

The FIGURE is a schematic of a steam methane reformer with a catalyst capable of conducting electricity per the invention.

### DETAILED DESCRIPTION OF THE INVENTION

The FIGURE is a schematic representation of a steam methane reformer A. Present in the reformer is a catalyst material B used in the reforming reaction. For purposes of this invention, this catalyst material B is a metal monolith supported catalyst, namely active catalyst coated on a metal surface that is capable of conducting electricity. The metal monolith supported catalyst is made of low alloy steel and is fabricated by wash coating a catalyst on a metallic support. The wash coating comprises coating the metal structure support with a ceramic material type alumina, drying the coating and impregnating the coating with a reforming material substrate selected from the group consisting of nickel and ruthenium.

20 to 30 megawatts of electrical power are fed from source C to the metal monolith supported catalyst B.

The steam methane reformer A is typically used to produce hydrogen. Fuel and air are added to the steam methane reformer. The fuel which is typically a mixture of natural gas and process hydrocarbons tail gas is fed through line 1 into the steam methane reformer A. Air which is typically derived from the atmosphere is fed through line 2 to line 1 so that they enter the steam methane reformer together. The fuel is combusted to assist in keeping higher temperatures in the reformer thereby assisting in the catalyst reaction. The fuel is selected from the group consisting of methane, ethane, ethylene, propane, propylene, butanes, pentanes and hexanes.

Hydrocarbons such as natural gas are fed through line 3 where they will contact high temperature steam being fed into the steam methane reformer A through line 4. The steam and hydrocarbons will react in the presence of the metal monolith supported catalyst according to the reaction:

CH₄+H₂O→CO+3H₂ (1)

Typically this reforming reaction occurs at high temperatures of about 700° to 1100° C. The hydrogen is formed in a mixture with carbon monoxide. The hot synthesis gas is recovered through line 5 while the reaction byproducts of the fuel and air combustion reaction are recovered as flue gas through line 6 where they are treated in an environmentally correct manner.

By using the heat generated by the electrical resistance of the catalyst metal structure the amount of heat that is necessarily produced by the reaction of the fuel and the air will be less thereby reducing costs in terms of fuel as well as costs of treating the resultant flue gas.

The electric current contacting the metal monolith supported catalyst produces heat. The heat generated by the electric current contacting the metal monolith supported catalyst supplements the heat generated by the reaction of the fuel and air.

Heat released by electrical resistance of the metallic structure is controlled by an amount of current passing through the metallic structure. The heat released by the electrical resistance if about 10 to 15% of total power provided to produce hydrogen.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what we claim is:

1. A method for producing hydrogen in a steam methane reformer comprising the steps:
a) Feeding a mixture of fuel and air to a steam methane reformer;
b) Feeding a mixture of steam and hydrocarbons to the steam methane reformer;
c) Contacting the steam and hydrocarbons with a metal monolith supported catalyst;
d) Providing an electric current to the metal monolith supported catalyst; and
e) Recovering the hydrogen.

2. The method as claimed in claim 1 wherein the fuel is selected from the group consisting of methane, ethane, ethylene, propane, propylene, butanes, pentanes and hexanes.

3. The method as claimed in claim 1 wherein the hydrogen is formed in a mixture with carbon monoxide.

4. The method as claimed in claim 1 wherein the hydrocarbons that contact the metal monolith supported catalyst with the steam are selected from the group consisting of unconverted methane and carbon monoxide, unrecovered hydrogen and carbon dioxide.

5. The method as claimed in claim 1 wherein the electric current contacting the metal monolith supported catalyst produces heat.

6. The method as claimed in claim 5 wherein the heat generated by the electric current contacting the metal monolith supported catalyst supplements the heat generated by the reaction of the fuel and air.

7. The method as claimed in claim 1 wherein the metal monolith supported catalyst is made of low alloy steel.

8. The method as claimed in claim 1 wherein the metal monolith supported catalyst is fabricated by wash coating a catalyst on a metallic support.

9. The method as claimed in claim 8 wherein the wash coating comprises coating the metal structure support with a ceramic material type alumina, drying the coating and impregnating the coating with a reforming material substrate selected from the group consisting of nickel and ruthenium.

10. The method as claimed in claim 6 wherein heat released by electrical resistance of the metallic structure is controlled by an amount of current passing through the metallic structure.

11. The method as claimed in claim 6 wherein the heat released by the electrical resistance if about 10 to 15% of total power provided to produce hydrogen.

12. A method for reducing the amount of fuel and air used in producing hydrogen in a steam methane reformer comprising the steps:
a) Feeding a mixture of fuel and air to a steam methane reformer;
b) Feeding a mixture of steam and hydrocarbons to the steam methane reformer;
c) Contacting the steam and hydrocarbons with a metal monolith supported catalyst;
d) Providing an electric current to the metal monolith supported catalyst; and
e) Recovering the hydrogen.

13. The method as claimed in claim 12 wherein the fuel is selected from the group consisting of methane, ethane, ethylene, propane, propylene, butanes, pentanes and hexanes.

14. The method as claimed in claim 12 wherein the hydrogen is formed in a mixture with carbon monoxide.

15. The method as claimed in claim 12 wherein the hydrocarbons that contact the metal monolith supported catalyst with the steam are selected from the group consisting of unconverted methane and carbon monoxide, unrecovered hydrogen and carbon dioxide.

16. The method as claimed in claim 12 wherein the electric current contacting the metal monolith supported catalyst produces heat.

17. The method as claimed in claim 16 wherein the heat generated by the electric current contacting the metal monolith supported catalyst supplements the heat generated by the reaction of the fuel and air.

18. The method as claimed in claim 12 wherein the metal monolith supported catalyst is made of low alloy steel.

19. The method as claimed in claim 12 wherein the metal monolith supported catalyst is fabricated by wash coating a catalyst on a metallic support.

20. The method as claimed in claim 19 wherein the wash coating comprises coating the metal structure support with a ceramic material type alumina, drying the coating and impregnating the coating with a reforming material substrate selected from the group consisting of nickel and ruthenium.

21. The method as claimed in claim 17 wherein heat released by electrical resistance of the metallic structure is controlled by an amount of current passing through the metallic structure.

22. The method as claimed in claim 17 wherein the heat released by the electrical resistance if about 10 to 15% of total power provided to produce hydrogen.

23. An improved method for producing hydrogen in a steam methane reformer comprising the steps:
a) Feeding a mixture of fuel and air to a steam methane reformer;
b) Feeding a mixture of steam and hydrocarbons to the steam methane reformer;
c) Contacting the steam and hydrocarbons with a metal monolith supported catalyst; and
d) Recovering the hydrogen, the improvement comprising feeding an electric current to the metal monolith supported catalyst.

24. The method as claimed in claim 23 wherein the fuel is selected from the group consisting of methane, ethane, ethylene, propane, propylene, butanes, pentanes and hexanes.

25. The method as claimed in claim 23 wherein the hydrogen is formed in a mixture with carbon monoxide.

26. The method as claimed in claim 23 wherein the hydrocarbons that contact the metal monolith supported catalyst with the steam are selected from the group consisting of unconverted methane and carbon monoxide, unrecovered hydrogen and carbon dioxide.

27. The method as claimed in claim 23 wherein the electric current contacting the metal monolith supported catalyst produces heat.

28. The method as claimed in claim 27 wherein the heat generated by the electric current contacting the metal monolith supported catalyst supplements the heat generated by the reaction of the fuel and air.

29. The method as claimed in claim 23 wherein the metal monolith supported catalyst is made of low alloy steel.

30. The method as claimed in claim 23 wherein the metal monolith supported catalyst is fabricated by wash coating a catalyst on a metallic support.

31. The method as claimed in claim 30 wherein the wash coating comprises coating the metal structure support with a ceramic material type alumina, drying the coating and impregnating the coating with a reforming material substrate selected from the group consisting of nickel and ruthenium.

32. The method as claimed in claim 27 wherein heat released by electrical resistance of the metallic structure is controlled by an amount of current passing through the metallic structure.

33. The method as claimed in claim 27 wherein the heat released by the electrical resistance if about 10 to 15% of total power provided to produce hydrogen.
